(19) United States
(12) Patent Application Publication
(10) Pub. No.: US 2024/0102618 A1
(43) Pub. Date: Mar. 28, 2024

(54) TANK DEVICE FOR TEMPERATURE PRESSURE RELIEF IN A HYDROGEN TANK

(71) Applicant: Robert Bosch GmbH, Stuttgart (DE)

(72) Inventors: Hans-Arndt Freudigmann, Tuebingen (DE); Bernd Stuke, Leonberg (DE); Olaf Ohlhafer, Erligheim (DE)

(21) Appl. No.: 18/255,449

(22) PCT Filed: Nov. 22, 2021
(86) PCT No.: PCT/EP2021/082476

§ 371 Date: Jun. 1, 2023

(30) Foreign Application Priority Data
Dec. 15, 2020 (DE) 10 2020 215 929.7

(51) Int. Cl. F17C 13/08; F17C 1/14; F17C 7/02; H01M 8/04082; H01M 8/04089

(52) U.S. Cl. CPC F17C 13/084; F17C 1/14; F17C 7/02; H01M 8/04089; H01M 8/04201; F17C 2203/0639; F17C 2205/0111; F17C 2205/0134; F17C 2205/0332; F17C 2205/0352; F17C 2221/012; F17C 2270/0168; F17C 2270/0184; H01M 2250/20

(57) ABSTRACT

Disclosed is a tank device (1) for temperature pressure relief in a hydrogen tank, the tank device (1) comprising at least two tank containers (10) and a supply line (4) that can be connected to the tank containers (10). Each of the at least two tank containers (10) includes at least one shut-off valve (8) at one end (26), said shut-off valve (8) being located between the tank container (10) and the supply line (4). Furthermore, the tank containers (10) are entirely surrounded by a housing element (12) and/or encapsulated, in particular pressure-tightly, towards the surroundings (120) by means of the housing element (12), and at least one sacrificial container (14) is arranged in the tank device (1), said sacrificial container (14) being fluidically connected to the tank containers (10) via a pressure relief valve (13).

### BACKGROUND

The invention relates to a tank device for temperature pressure relief in a hydrogen tank, for example for use in vehicles having a fuel cell drive or in vehicles having a hydrogen drive.

DE 10 2017 212 485 A1 describes a device for storing compressed fluids that serve as fuel for a vehicle, the device comprising at least two tubular tank modules and at least one high-pressure fuel distributor having at least one integrated control and safety system. In addition, the at least two tubular tank modules are made of metal and are modularly connected to the at least one high-pressure fuel allotment with the at least one integrated control and safety technology to form a module in flexible geometry.

For example, in case of an accident with the device for storing compressed fluids or, in the event of a breakage of a conduit within the device, the spill valve can close such that gas cannot leak out of the storage unit. Furthermore, for example, in the event of a fire or temperature increase beyond a predetermined threshold value, the safety valve is intended to ensure that, e.g., the hydrogen can be diverted out of the tank module in order to prevent an explosion of the tank module or even of the entire device for the storage of compressed fluids.

A variety of valves are required for these safety precautions, thereby increasing the complexity of the overall gas storage system and its cost. Furthermore, depending on the position of the safety valve, it must be ensured that it is also triggered when the source of fire is not in proximity to the safety valve in order to prevent a possible explosion of the gas storage system.

### SUMMARY

In contrast to the foregoing, the tank device according to the invention has the advantage that, in case of heat effects on the tank device, the tank device is emptied in a constructively simple, straightforward, and quick manner, whereby a bursting of the tank device is prevented by targeted discharging of the gaseous medium, e.g., hydrogen.

In this context, the tank device for temperature pressure relief in a hydrogen tank comprises at least two tank containers and a supply line that can be connected to the tank containers. Each of the at least two tank containers includes at least one shut-off valve at one end, said shut-off valve being located between the tank container and the supply line. Furthermore, the tank containers are entirely surrounded by a housing element and/or encapsulated, in particular pressure-tightly, towards the surroundings by means of the housing element, with at least one sacrificial container being arranged in the tank device. The sacrificial container is fluidically connected to the tank containers via a pressure relief valve.

Thus, it can be easily ensured that, in the event of an emergency, e.g., for a fire breaking out, the building pressure in the tank containers can be reduced via the sacrificial container. This is because, if the pressure in the tank containers increases due to the heat input, the pressure relief valve triggers on the sacrificial container so that hydrogen from the tank containers can be drained into the sacrificial tank container. In this way, the building pressure in the tank containers is reduced by means of one or more sacrificial containers. A bursting of the tank device can thus be prevented.

In the first advantageous embodiment, it is provided that the sacrificial container is exclusively filled at 1 bar of nitrogen. Thus, a pressure reduction of the tank containers can be easily achieved.

In a further embodiment of the invention, it is advantageously provided that the sacrificial container is exclusively filled at 1 bar of hydrogen. Thus, a pressure reduction of the tank containers can be easily achieved.

Furthermore, it should be ensured that the sacrificial container does not contain oxygen due to the detonating gas reaction with a compound of hydrogen and oxygen.

In an advantageous embodiment, it is provided that at least one safety valve is arranged at a different end of the tank container.

Thus, it can be easily ensured that, in the event of an emergency, e.g., a fire breaking out, there is sufficient time to be able to safely open the safety valve in order to discharge the stored hydrogen. This is because, depending on the heat input on the tank device, i.e., how far the heat input is from the surroundings of the safety valves, the triggering of the latter is delayed. However, if the pressure in the tank containers then increases due to the heat input, the pressure relief valve on the sacrificial container triggers so that hydrogen from the tank containers can be drained into the sacrificial tank container. In this way, the building pressure in the tank containers is reduced by means of one or more sacrificial containers. Thus, even with potentially delayed triggering of the safety valves, a bursting of the tank device can be prevented, or, depending on the heat input and pressure build-up, an opening of the safety valves may no longer be necessary.

In a further embodiment of the invention, it is advantageously provided that the safety valve comprises a fluid-filled glass ampoule, such that when the temperature of the surroundings increases, the glass ampoule is ruptured, and thus the safety valve can be unlocked.

In one advantageous embodiment, it is provided that the safety valve comprises a fusible medium, e.g., wax, in which case the fusible medium melts upon an increase in temperature of the surroundings, and the safety valve can thus be unlocked.

In this way, it is ensured that the safety valve can be reliably opened one time in an emergency, and the hydrogen is discharged from the tank containers in order to prevent a bursting of the tank device.

In a further embodiment of the invention, it is advantageously provided that the tank containers can be connected to a discharge line by means of the safety valve. In the event of an emergency, the gaseous medium, e.g., hydrogen, can be easily discharged from the tank containers and, e.g., emitted to the surrounding.

In one advantageous embodiment, it is provided that the at least two tank containers are made of steel. By selecting this material, cost savings are achieved.

In an advantageous embodiment, it is provided that the at least two tank containers can be connected to a supply region of a consumer system via the shut-off valve, preferably a fuel cell system anode region.

The described tank device is preferably suited for use in a fuel cell system for storing hydrogen for operating a fuel cell.

In advantageous uses, the tank device can be used in vehicles with a fuel cell drive.

In advantageous uses, the tank device can be used in vehicles with a hydrogen drive.

### BRIEF DESCRIPTION OF THE DRAWINGS

The drawings show exemplary embodiments of a tank device according to the invention for temperature pressure relief in a hydrogen tank. The following are shown:

FIG. 1 a first exemplary embodiment of a tank device according to the invention in a schematic view,

FIG. 2 a second exemplary embodiment of a tank device according to the invention in a schematic view.

### DETAILED DESCRIPTION

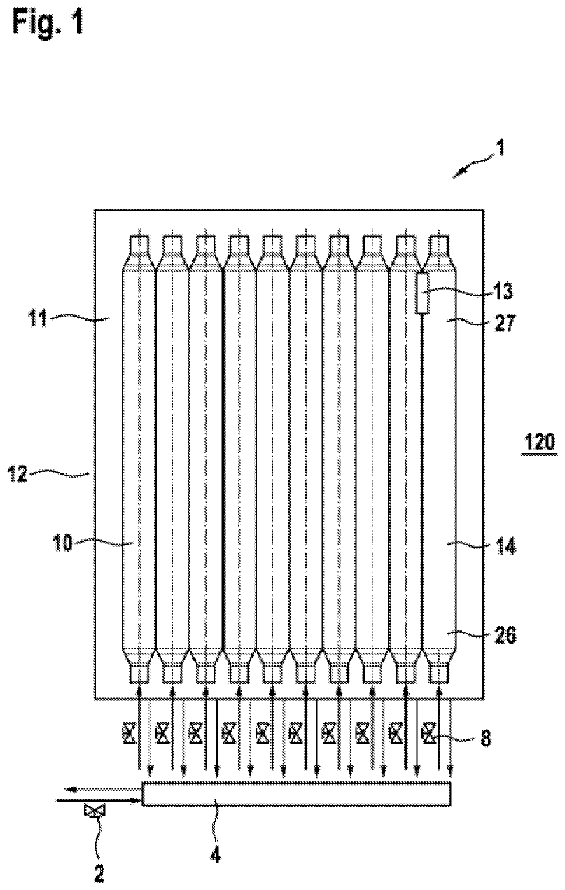

FIG. 1 shows a first exemplary embodiment of a tank device 1 according to the invention in a schematic view. The tank device 1 comprises a plurality of tank containers 10, which are substantially cylindrical in form and made of steel. The respective ends 26, 27 of the respective tank container 10 have a conical taper and thus a typical bottleneck structure. In addition, a sacrificial container 14 is arranged in the tank device 1 adjacent to the tank containers, which is fluidically connected to the tank containers 10 by means of a pressure relief valve 13. The sacrificial container 14 is exclusively filled at 1 bar of nitrogen. Furthermore, it should be ensured that the sacrificial container does not contain oxygen due to the detonating gas reaction with a compound of hydrogen and oxygen. The sacrificial container 14 is therefore at atmospheric pressure. In an alternative embodiment, the sacrificial container 14 can also be filled exclusively at 1 bar of hydrogen.

In further embodiments, any desired number of sacrificial containers 14 can be arranged in the tank device 1.

Furthermore, the tank containers 10 and the sacrificial container 14 are entirely surrounded by a housing element 12 and pressure-tightly encapsulated towards the surroundings 120.

The one end 26 of the respective tank container 10 is connected to a supply line 4 by means of a shut-off valve 8. This supply line 4 is connected by means of a further valve 2, e.g., to a supply region of a consumer system, e.g., an anode region of a fuel cell system. For example, the tank device 1 can provide hydrogen for a fuel cell arranged in a fuel cell system.

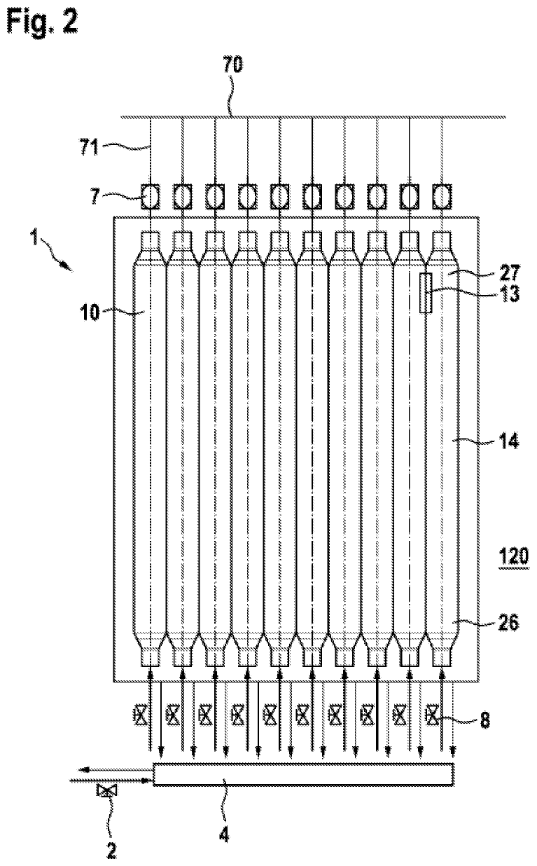

FIG. 2 shows a second exemplary embodiment of a tank device 1 according to the invention in a schematic view. The second exemplary embodiment largely corresponds in function and design to the first exemplary embodiment.

In addition, the respective tank container 10 is connected with its other end 27 to a discharge line 70 via a tank discharge line 71. A safety valve 7 is arranged in the tank discharge line 71 for each tank container 10.

The safety valves 7 comprise a fluid-filled glass ampoule so that, when the temperature of the surroundings 120 increases, the glass ampoule is ruptured and thus the safety valve 7 is unlocked and opened.

In alternative embodiments, the safety valve 7 comprises a fusible medium, e.g., wax, such that it melts upon an increase in temperature of the surroundings 120 and thus the safety valve 7 can be unlocked.

In one alternative embodiment, it is also possible for the sacrificial container 14 to be fluidically connected to the individual tank containers 10 via a respective pressure relief valve 13.

The tank device 1 functions as follows: With proper operation of the fuel cell system, the fuel cell is supplied with hydrogen from the tank containers 10. The shut-off valves 8 are in this case designed to ensure a safe supply to the fuel cell.

If, for example, there is a heat input on the tank device 1 or the tank containers 10 due to fire, in the first exemplary embodiment the building pressure in the tank containers 10 is to be reduced as quickly as possible in order to, e.g., prevent an explosion of the tank containers 10. In this case, supply of power to the shut-off valves 8 is usually also interrupted, so that hydrogen can no longer escape from the tank containers 10.

The pressure in the respective tank container 10 already increases upon impact of the heat input on the tank container 1. Thus, in order to prevent the tank container tank 10 from bursting, the sacrificial container 14 is fluidically connected to the tank containers 10 by means of the pressure relief valve 13. At too high a predetermined pressure in the tank containers 10, the pressure relief valve is opened and hydrogen can then flow into the sacrificial container 14 in order to reduce pressure in the tank containers 10. The sacrificial container 14 is at atmospheric pressure and contains only nitrogen or hydrogen, so that the excess pressure in the tank containers 10 resulting from the heat input can be discharged into the sacrificial container 14.

If, for example, a heat input to the tank device 1 or the tank containers 10 is caused by fire, in the second exemplary embodiment the safety valves 7 are to be triggered as quickly as possible after the heat input occurs so that the hydrogen from the tank containers 10 can be conducted via the tank discharge line 71 into the discharge line 70 in order to, e.g., prevent an explosion of the tank containers 10. The supply of power to the shut-off valves 8 is in this case usually also interrupted, so that hydrogen can no longer escape from the tank containers 10.

Depending on the region of the tank device where heat is introduced, some delay can occur until the safety valves 7 open due to the heat input and the corresponding heat conduction. However, the pressure in the respective tank container 10 already increases upon impact of the heat input on the tank container 1. Thus, in order to prevent the tank container tank 10 from bursting, the sacrificial container 14 is fluidically connected to the tank containers 10 by means of the pressure relief valve 13 or by means of a respective pressure relief valve 13 for each tank container 10. The sacrificial container 14 is in a vacuum state so that excess pressure in the tank containers 10 resulting from the heat input can be output into the sacrificial container 14.

Thus, in the event of overheating, the resulting pressure can be at least partially discharged to the tank container 10 via the sacrificial container 14, and the pressure in the tank containers 10 can be reduced. Thus, more time is allowed for the transfer of heat to the safety valves 7, and a safe triggering of the safety valve 7 is permitted. The pressure for opening the pressure relief valve 13 is in this case somewhat greater than the maximum allowable pressure in the tank containers 10, but less than the bursting pressure of the tank containers 10, i.e., the tank containers 10 are not ruptured due to the heat input. Said pressure thus lies within the safety range of the tank container 10. Therefore, just enough pressure is reduced so that the respective tank container 10 is not damaged.

If the heat input to the tank container 10 is ended or the heat input to the tank container 10 is not so strong that there is so much overpressure that the safety valves 7 open, then a discharge of the hydrogen from the tank containers 10 into the sacrificial container 14 is sufficient, and the safety valves 7 remain closed. Thus, no hydrogen is output to the surroundings 120. This is particularly advantageous when the hydrogen-powered vehicle is parked in a closed space, such as a parking garage. Thus, a possible hazardous situation in the closed space due to leaking hydrogen is prevented.

However, if the heat input to the tank containers 10 is too high, then the safety valves 7 are triggered and a gaseous medium, hydrogen, flows out of the tank containers 10 towards the discharge line 12 and is safely emptied into the surroundings 120.

The opening of the safety valve 7 is irreversible, because, in the event of a fire, the tank containers 10 are to be quickly and efficiently emptied and the safety valve 7 is to remain in the open state in order to ensure a complete emptying.

However, the tank device 1 for storing a gaseous medium can be used not only in fuel cell-powered vehicles, but also for, e.g., hydrogen storage in vehicles having a hydrogen burner as the drive.

1. A tank device (1) for temperature pressure relief in a hydrogen tank, wherein the tank device (1) comprises at least two tank containers (10) and a supply line (4) that can be connected to the tank containers (10), wherein each of the at least two tank containers (10) includes at least one shut-off valve (8) at one end (26), said shut-off valve (8) being located between the tank container (10) and the supply line (4), wherein the tank containers (10) are entirely surrounded by a housing element (12) and/or encapsulated from surroundings (120) by the housing element (12), wherein at least one sacrificial container (14) is arranged in the tank device (1), said sacrificial container (14) being fluidically connected to the tank containers (10) via a pressure relief valve (13).

2. The tank device (1) according to claim 1, wherein the sacrificial container (14) is filled exclusively at 1 bar of nitrogen.

3. The tank device (1) according to claim 1, wherein the sacrificial container (14) is filled exclusively at 1 bar of hydrogen.

4. The tank device (1) according to claim 1, wherein at least one safety valve (7) is arranged at a different end (27) of the tank container (10).

5. The tank device (1) according to claim 4, wherein the safety valve (7) comprises a fluid-filled glass ampoule, so that the glass ampoule is ruptured upon an increase in temperature of the surroundings (120) and the safety valve (7) can thus be unlocked.

6. The tank device (1) according to claim 4, wherein the safety valve (7) comprises a fusible medium, wherein the fusible medium melts upon an increase in temperature of the surroundings (120) and the safety valve (7) can thus be unlocked.

7. The tank device (1) according to claim 4, wherein the tank containers (10) can be connected to a discharge line (70) by the safety valve (7).

8. The tank device (1) according to claim 1, wherein the at least two tank containers (10) are made of steel.

9. The tank device (1) according to claim 1, wherein the at least two tank containers (10) can be connected to a supply region of a consumer system via the shut-off valve (8) and the supply line (4).

10. A fuel cell system having a tank device (1) according to claim 1.

11. A fuel cell-powered vehicle having a tank device (1) according claim 1.

12. A hydrogen-powered vehicle having a tank device (1) according to claim 1.

13. The tank device (1) according to claim 1, wherein the tank containers (10) are entirely encapsulated in a pressure-tight manner from the surroundings (120) by the housing element (12).

14. The tank device according to claim 6, wherein the fusible medium is wax.

15. The tank device according to claim 9, wherein the supply region of the consumer system is an anode region of a fuel cell system.
